(19) United States
(12) Patent Application Publication
(10) Pub. No.: US 2016/0041437 A1
(43) Pub. Date: Feb. 11, 2016

(54) PIXEL ARRAY AND HEAD UP DISPLAY

(71) Applicant: Au Optronics Corporation, Hsinchu (TW)

(72) Inventors: Hui-Feng Lin, Taichung City (TW); Sheng-Wen Cheng, Hsinchu City (TW)

(21) Appl. No.: 14/557,456

(22) Filed: Dec. 2, 2014

(30) Foreign Application Priority Data
Aug. 6, 2014 (TW) 103126883

(51) Int. Cl. G02F 1/1343; G02F 1/1362; G02B 27/01

(52) U.S. Cl. CPC G02F 1/134336; G02B 27/01; G02F 1/136286; G02B 2027/0112; G02B 2027/0118; G02F 2001/134345

(57) ABSTRACT

A pixel array that includes a plurality of repeat unit sets is provided. Each of the repeat unit sets includes a first scan line, a second scan line, a first data line, a second data line, a third data line, a fourth data line, at least two first color sub-pixels, at least two second color sub-pixels, at least two third color sub-pixels, and a fourth color sub-pixel. Each of the first color sub-pixels, the second color sub-pixels, and the third color sub-pixels has a first short side length and a first long side length. The fourth color sub-pixel has a second short side length and a second long side length, and the second long side length is greater than the first long side length.

### CROSS-REFERENCE TO RELATED APPLICATION

This application claims the priority benefit of Taiwan application serial no. 103126883, filed on Aug. 6, 2014. The entirety of the above-mentioned patent application is hereby incorporated by reference herein and made a part of this specification.

### FIELD OF THE INVENTION

The invention relates to a pixel array and a display; more particularly, the invention relates to a pixel array and a head up display (HUD).

### DESCRIPTION OF RELATED ART

With the advancement of science and technology, liquid crystal displays (LCD) have been extensively applied to various mobile information display devices, such as mobile phones, tablet PCs, and head up displays (HUD).

In general, the HUD employs a thin film transistor-liquid crystal display (TFT-LCD) panel as an image source; together with an illumination source and on account of the design of an optical system, an image can be projected on a windshield along a light path. In order for the image to be clearly projected onto the windshield, the HUD often requires great backlight brightness. However, the light energy conversion efficiency of the conventional LCD is insufficient.

To make effective use of the backlight brightness of the LCD, white sub-pixels (W) are often configured in a conventional RGB LCD, so as to enhance the transmittance of the LCD. Compared to the conventional RGB LCD, however, the RGBW LCD displays the pure color image with the relatively low brightness and the white color image with the relatively high brightness. Accordingly, there is an imperious demand for a pixel array that is capable of enhancing the transmittance of a display panel without compromising the image quality of the display panel.

### SUMMARY OF THE INVENTION

The invention is directed to a pixel array that is capable of enhancing a transmittance of a display panel without compromising the image quality of the display panel.

The invention is also directed to a head up display (HUD) characterized by a favorable transmittance and satisfactory display quality.

In an embodiment of the invention, a pixel array that includes a plurality of repeat unit sets is provided. Each of the repeat unit sets includes a first scan line, a second scan line, a first data line, a second data line, a third data line, a fourth data line, at least two first color sub-pixels, at least two second color sub-pixels, at least two third color sub-pixels, and a fourth color sub-pixel. At least two first color sub-pixels are electrically connected to the first data line and are electrically connected to the first scan line and the second scan line, respectively. At least two second color sub-pixels are electrically connected to the second data line and are electrically connected to the first scan line and the second scan line, respectively. At least two third color sub-pixels are electrically connected to the third data line and are electrically connected to the first scan line and the second scan line, respectively. The fourth color sub-pixel is electrically connected to the fourth data line and electrically connected to the first scan line or the second scan line. Each of the first color sub-pixels, the second color sub-pixels, and the third color sub-pixels has a first short side length and a first long side length. The fourth color sub-pixel has a second short side length and a second long side length, and the second long side length is greater than the first long side length.

In an embodiment of the invention, another pixel array that includes a plurality of repeat unit sets is provided. Each of the repeat unit sets includes a first scan line, a second scan line, a first data line, a second data line, a third data line, at least two first color sub-pixels, at least two second color sub-pixels, at least two third color sub-pixels, and a fourth color sub-pixel. At least two first color sub-pixels are electrically connected to the first data line and are electrically connected to the first scan line and the second scan line, respectively. At least two second color sub-pixels are electrically connected to the second data line and are electrically connected to the first scan line and the second scan line, respectively. At least two third color sub-pixels are electrically connected to the third data line and are electrically connected to the first scan line and the second scan line, respectively. The fourth color sub-pixel is electrically connected to the first data line, the second data line, or the third data line, and the fourth color sub-pixel is electrically connected to the first scan line or the second scan line. A long side length of the fourth color sub-pixel is parallel to short side lengths of the first, second, and third color sub-pixels.

In an embodiment of the invention, a HUD that includes a display module is provided. The display panel includes a plurality of light emitting units and a display panel. The light emitting units are adapted to emit an illumination beam. The display panel includes said pixel array and is configured to generate an image beam.

In view of the above, each of the repeat unit sets in the pixel array provided in an embodiment of the invention includes sub-pixels with four different colors. The long side length of the fourth color sub-pixel is greater than the short side length of each of the first, second, and third color sub-pixels. Thereby, the pixel array provided herein is capable of enhancing the transmittance of the display panel without compromising the image quality of the display panel.

Several exemplary embodiments accompanied with figures are described in detail below to further describe the invention in details.

### BRIEF DESCRIPTION OF THE DRAWINGS

FIG. 1 is a schematic top view illustrating a pixel array according to an embodiment of the invention.

FIG. 2 is a schematic top view illustrating a repeat unit set according to a first embodiment of the invention.

FIG. 3 is a schematic top view illustrating another repeat unit set according to the first embodiment of the invention.

FIG. 4 is a schematic top view illustrating still another repeat unit set according to the first embodiment of the invention.

FIG. 5A is a schematic top view illustrating a conventional RGB pixel array.

FIG. 5B is a schematic top view illustrating a RGBW pixel array according to a first embodiment of the invention.

FIG. 6 is a schematic top view illustrating a repeat unit set according to a second embodiment of the invention.

FIG. 7 is a schematic top view illustrating another repeat unit set according to the second embodiment of the invention.

FIG. 8 is a schematic top view illustrating still another repeat unit set according to the second embodiment of the invention.

FIG. 9 is a schematic top view illustrating still another repeat unit set according to the second embodiment of the invention.

FIG. 10 is a schematic top view illustrating another repeat unit set according to the second embodiment of the invention.

FIG. 11 is a schematic top view illustrating still another repeat unit set according to the second embodiment of the invention.

FIG. 12A is a schematic top view illustrating a conventional RGB pixel array.

FIG. 12B is a schematic top view illustrating a RGBW pixel array according to a second embodiment of the invention.

FIG. 13 is a schematic top view illustrating a repeat unit set according to a third embodiment of the invention.

FIG. 14 is a schematic top view illustrating another repeat unit set according to the third embodiment of the invention.

FIG. 15 is a schematic top view illustrating still another repeat unit set according to the third embodiment of the invention.

FIG. 16 is a schematic top view illustrating still another repeat unit set according to the third embodiment of the invention.

FIG. 17 is a schematic top view illustrating still another repeat unit set according to the third embodiment of the invention.

FIG. 18 is a schematic top view illustrating still another repeat unit set according to the third embodiment of the invention.

FIG. 19 is a schematic top view illustrating a repeat unit set according to a fourth embodiment of the invention.

FIG. 20 is a schematic top view illustrating a repeat unit set according to a fifth embodiment of the invention.

FIG. 21 is a schematic view illustrating a head up display (HUD) display according to an embodiment of the invention.

### DETAILED DESCRIPTION OF DISCLOSED EMBODIMENTS

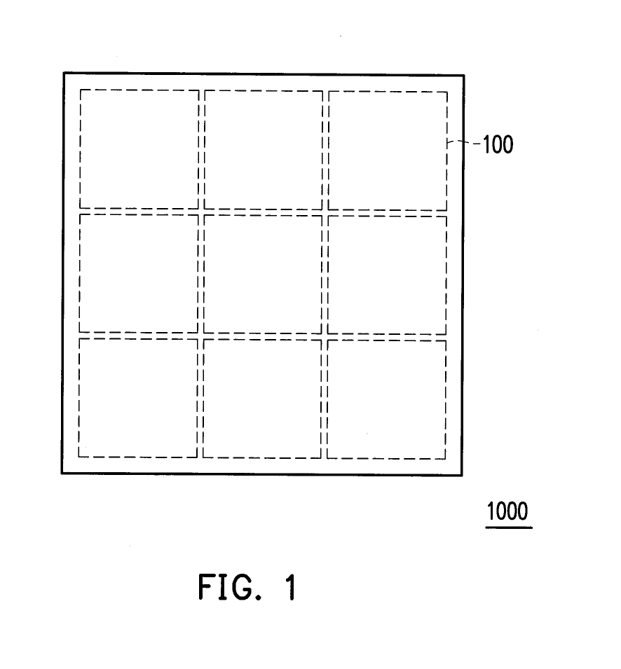

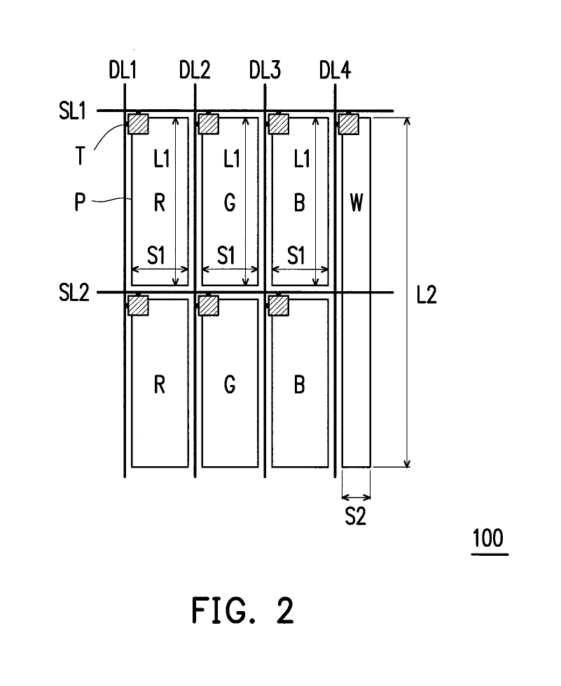

FIG. 1 is a schematic top view illustrating a pixel array according to an embodiment of the invention. The pixel array 1000 may include a plurality of repeat unit sets 100. The repeat unit sets 100 may be arranged in an array, as shown in FIG. 1. In the present embodiment, identical unit sets are repeatedly arranged in an array, and each of the identical unit sets is named the repeat unit set. FIG. 2 is a schematic top view illustrating a repeat unit set according to a first embodiment of the invention. With reference to FIG. 1 and FIG. 2, the repeat unit set 100 provided in the present embodiment includes a first scan line SL1, a second scan line SL2, a first data line DL1, a second data line DL2, a third data line DL3, a fourth data line DL4, and seven sub-pixels. The seven sub-pixels are two first color sub-pixels R, two second color sub-pixels G, two third color sub-pixels B, and a fourth color sub-pixel W. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto. According to another embodiment, the first color sub-pixels R, the second color sub-pixels G, the third color sub-pixels B, and the fourth color sub-pixel W may be of other colors.

With reference to FIG. 2, in the first row in the repeat unit set 100, the first color sub-pixel R, the second color sub-pixel G, the third color sub-pixel B, and one portion of the fourth color sub-pixel W are arranged from left to right; in the second row in the repeat unit set 100, the first color sub-pixel R, the second color sub-pixel G, the third color sub-pixel B, and the other portion of the fourth color sub-pixel W are arranged from left to right. Specifically, the fourth color sub-pixel W is located in both of the first and second rows. Each of the sub-pixels includes a driver device T, a pixel electrode P, and a display medium (not shown). The driver device T can be electrically connected to the corresponding first scan line SL1, the corresponding second scan line SL2, the corresponding first data line DL1, the corresponding second data line DL2, the corresponding third data line DL3, and the corresponding fourth data line DL4. If the pixel array 1000 shown in FIG. 1 is applied to an LCD, the driver device T is a thin film transistor (TFT), for instance, and the display medium is liquid crystal molecules, for instance; however, the invention is not limited thereto. By contrast, if the pixel array is applied to an organic electroluminescent display panel (e.g., an organic light-emitting diode, OLED), the driver device T includes two TFTs and one capacitor, for instance; however, the invention is not limited thereto.

As shown in FIG. 2, two adjacent first color sub-pixels R in the same column are electrically connected to the first data line DL1 and are electrically connected to the first scan line SL1 and the second scan line SL2, respectively. Similarly, two second color sub-pixels G are electrically connected to the second data line DL2 and are electrically connected to the first scan line SL1 and the second scan line SL2, respectively. Two third color sub-pixels B are electrically connected to the third data line DL3 and are electrically connected to the first scan line SL1 and the second scan line SL2, respectively. Note that the fourth color sub-pixel W is electrically connected to the fourth data line DL4; besides, the fourth color sub-pixel W is electrically connected to one of the first scan line SL1 and the second scan line SL2, for instance. In the present embodiment, the fourth color sub-pixel W is electrically connected to and driven by the first scan line SL1 not driven by the second scan line SL2, which should however not be construe as a limitation to the invention. However, in another example, the fourth color sub-pixel W is electrically connected to and driven by the second scan line SL2 not driven by the first scan line SL1. That is, in the present embodiment, through the algorithm built in a panel signal processing unit, the three primary color RGB signals in the first and second rows may be converted into the RGBW signal corresponding to the pixel design of the display panel, i.e., two sets of three primary color RGB signals and the signal of one set of the fourth color sub-pixel W, so as to output the RGBW image corresponding to the backlight brightness of the display panel.

As shown in FIG. 2, each of the first color sub-pixels R, the second color sub-pixels G, and the third color sub-pixels B has a first short side length S1 and a first long side length L1. The fourth color sub-pixel W has a second short side length S2 and a second long side length L2. In the present embodiment, the second long side length L2 is greater than the first long side length L1, and the second long side length L2 is slightly greater than twice the first long side length L1; however, the invention is not limited thereto. In the present embodiment, the second short side length S2 is less than the first short side length S1, and the second short side length S2 is half the first short side length S1; however, the invention is not limited thereto. According to the present embodiment, an area of each of the first color sub-pixels R, an area of each of the second color sub-pixels G, and an area of each of the third color sub-pixels B are equal, and the area of each of the first, second, and third color sub-pixels R, G, and B is substantially equal to an area of the fourth color sub-pixel W. However, the invention is not limited to the above.

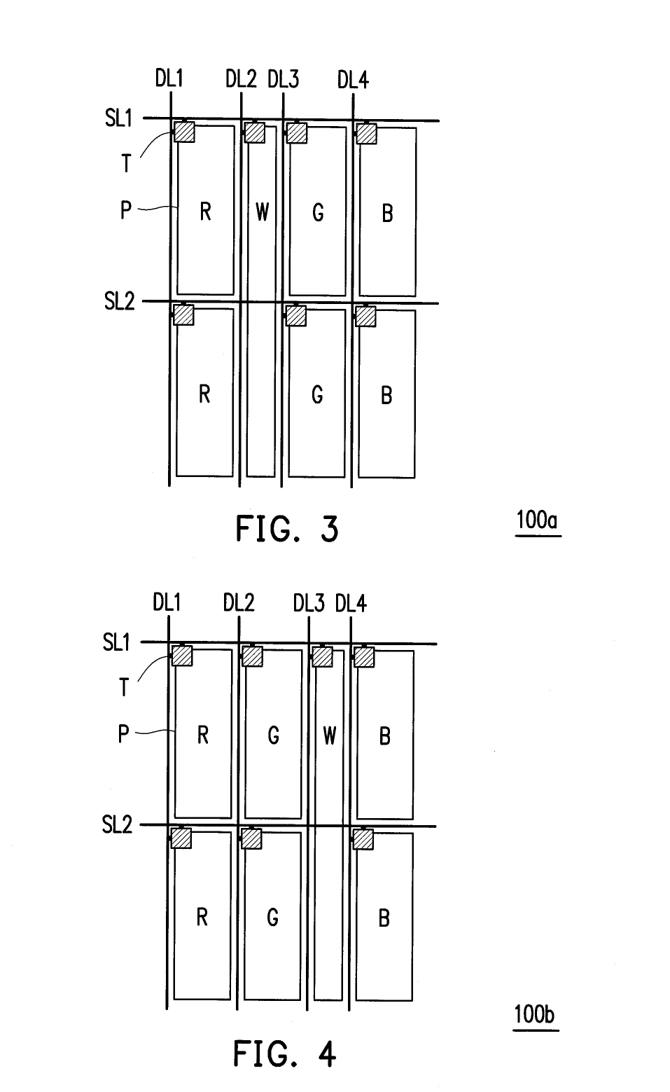

FIG. 3 is a schematic top view illustrating another repeat unit set according to the first embodiment of the invention. FIG. 4 is a schematic top view illustrating still another repeat unit set according to the first embodiment of the invention. With reference to FIG. 2 to FIG. 4, the repeat unit sets 100a and 100b provided in the present embodiment are similar to the repeat unit set 100 given in the previous embodiment; therefore, the identical or similar components in these embodiments are represented by the identical or similar reference numbers and will not be further explained. The difference among the repeat unit sets 100, 100a, and 100b lies in the arrangement of the fourth color sub-pixel W relative to the arrangement of the first, second, and third color sub-pixels R, G, and B.

With reference to FIG. 3, the repeat unit set 100a also includes the first scan line SL1, the second scan line SL2, the first data line DL1, the second data line DL2, the third data line DL3, the fourth data line DL4, two first color sub-pixels R, two second color sub-pixels G, two third color sub-pixels B, and the fourth color sub-pixel W. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto.

Compared to the repeat unit set 100 in which the fourth color sub-pixel W is located on the right-hand side of the third color sub-pixels B, the repeat unit set 100a has the fourth color sub-pixel W located between the first and second color sub-pixels R and G Similarly, the fourth color sub-pixel W is located in both of the first and second rows.

As shown in FIG. 3, two first color sub-pixels R are electrically connected to the first data line DL1 and are electrically connected to the first scan line SL1 and the second scan line SL2, respectively. Note that the fourth color sub-pixel W in the repeat unit set 100a is electrically connected to the second data line DL2, and the fourth color sub-pixel W is electrically connected to one of the first scan line SL1 and the second scan line SL2, for instance. Two second color sub-pixels G are electrically connected to the third data line DL3 and are electrically connected to the first scan line SL1 and the second scan line SL2, respectively. Two third color sub-pixels B are electrically connected to the fourth data line DL4 and are electrically connected to the first scan line SL1 and the second scan line SL2, respectively.

With reference to FIG. 4, the repeat unit set 100b also includes the first scan line SL1, the second scan line SL2, the first data line DL1, the second data line DL2, the third data line DL3, the fourth data line DL4, two first color sub-pixels R, two second color sub-pixels G, two third color sub-pixels B, and the fourth color sub-pixel W. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto.

Compared to the repeat unit set 100 in which the fourth color sub-pixel W is located on the right-hand side of the third color sub-pixels B, the repeat unit set 100b has the fourth color sub-pixel W located between the second and third color sub-pixels G and B. Similarly, the fourth color sub-pixel W is located in both of the first and second rows.

As shown in FIG. 4, two first color sub-pixels R are electrically connected to the first data line DL1 and are electrically connected to the first scan line SL1 and the second scan line SL2, respectively. Two second color sub-pixels G are electrically connected to the second data line DL2 and are electrically connected to the first scan line SL1 and the second scan line SL2, respectively. Note that the fourth color sub-pixel W in the repeat unit set 100b is electrically connected to the third data line DL3, and the fourth color sub-pixel W is electrically connected to one of the first scan line SL1 and the second scan line SL2, for instance. Two third color sub-pixels B are electrically connected to the fourth data line DL4 and are electrically connected to the first scan line SL1 and the second scan line SL2, respectively.

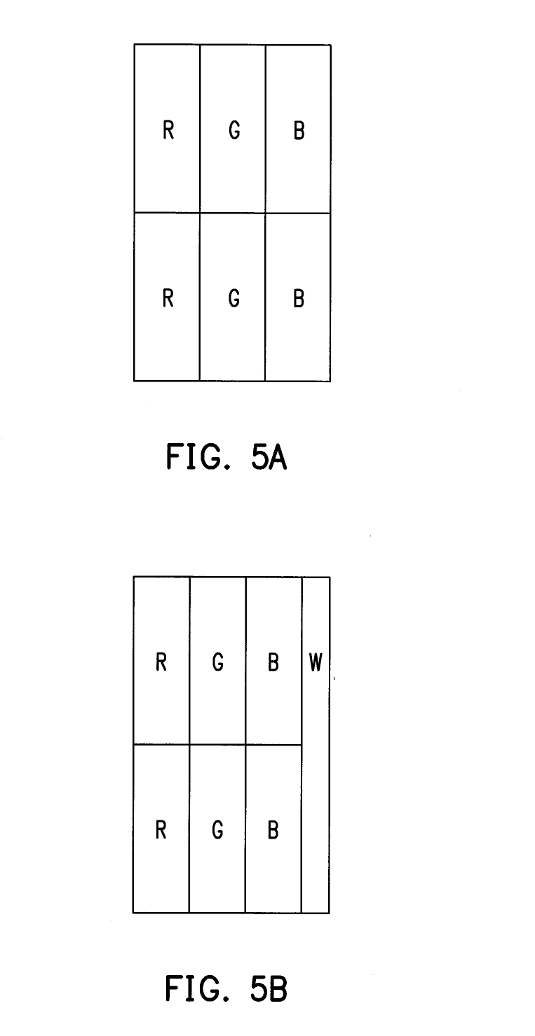

FIG. 5A is a schematic top view illustrating a conventional RGB pixel array. FIG. 5B is a schematic top view illustrating a RGBW pixel array according to a first embodiment of the invention. To clearly illustrate the invention, the driver device T, the scan lines, and the data lines are omitted in FIG. 5A and FIG. 5B. Besides, FIG. 5B shows the exemplary repeat unit set 100, while the RGBW pixel array provided in the present embodiment may be the repeat unit set 100a or the repeat unit set 100b, which should however not be construed as a limitation to the invention. With reference to FIG. 5A and FIG. 5B, the area of the repeat unit set 100 in the RGBW pixel array provided in the present embodiment is equal to the area of the RGB repeat unit in the conventional RGB pixel array. That is, the area of each of the first color sub-pixels R, the second color sub-pixels G, and the third color sub-pixels B in the repeat unit set 100 is smaller than the area of each of the sub-pixels R, G, and B in the conventional RGB pixel array.

For example, in the conventional RGBW pixel array, the pixel size of a unit set including four color sub-pixels of the 1.8 inch panel is 0.0855(width)×0.0855(length) mm², and the sub-pixel size of each of color sub-pixels R,G,B,W is 0.021375(width)×0.0855(length) mm². However, in the present embodiment, the sub-pixel size of each of color sub-pixels R,G,B is between 0.0214 mm (width) to 0.0221 mm(width)×0.0855 mm(length) and that of color sub-pixel W is between 0.0192 mm(width) to 0.0214 mm(width)×0.171 mm(length) so that pixel size of a unit set is 0.0855(width)×0.171(length) mm² in the present embodiment. Thereby, the resolution in the RGBW pixel array described herein is satisfactory.

In general, when a full-white image is displayed, the transmittance of the conventional RGBW pixel array may be raised to 120% of the transmittance of the conventional RGB pixel array; nevertheless, when a pure color image is displayed, the transmittance of the conventional RGBW pixel array is reduced to 85% of the transmittance of the conventional RGB pixel array. When a full-white image is displayed by a RGBW pixel array having the repeat unit set 100, 100a, or 100b described herein, the transmittance of said RGBW pixel array may be raised to 136% of the transmittance of the conventional RGB pixel array; when a pure color image is displayed by the RGBW pixel array having the repeat unit set 100, 100a, or 100b, the transmittance of said RGBW pixel array is slightly reduced to 97% of the transmittance of the conventional RGB pixel array. Accordingly, the transmittance of the RGBW pixel array of the present embodiment of the invention is 1.14 times the transmittance of the conventional RGBW pixel array while the pure color image is displayed; thereby, the issue of the overly dark pure color image can be effectively resolved, and the overall brightness of the display panel can be enhanced.

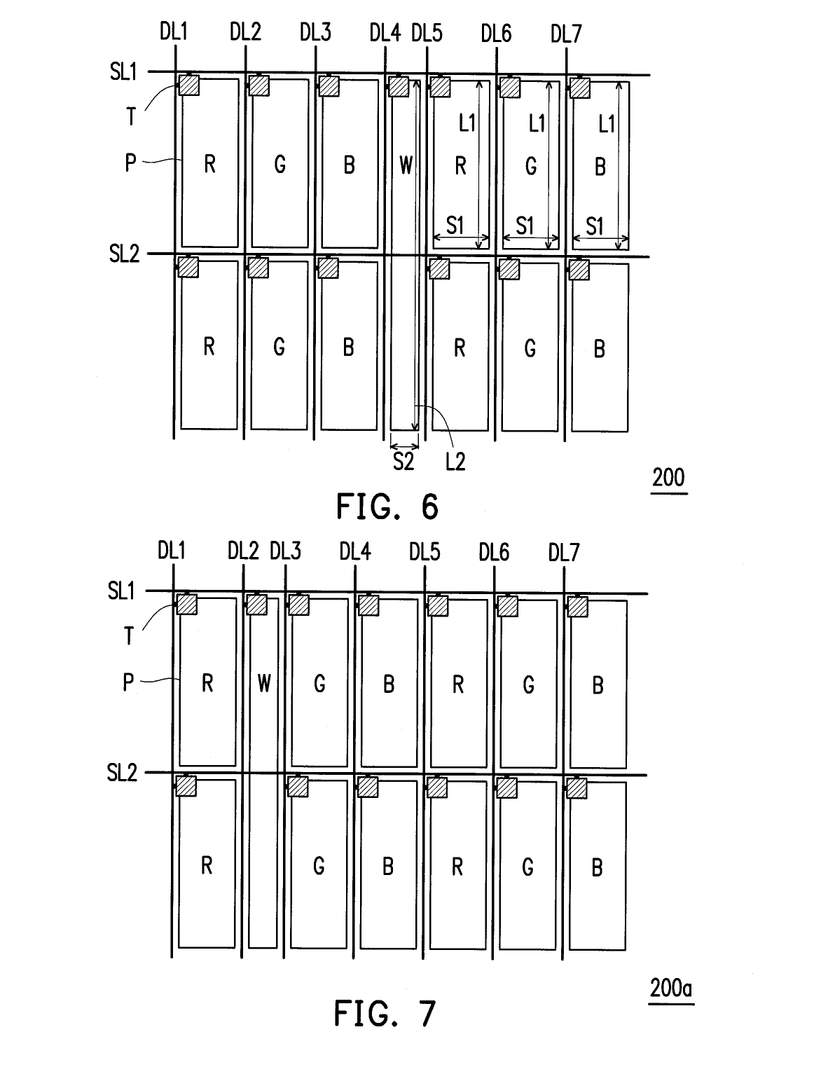

FIG. 6 is a schematic top view illustrating a repeat unit set according to a second embodiment of the invention. With reference to FIG. 2 and FIG. 6, the repeat unit set 200 shown in FIG. 6 is similar to the repeat unit set 100 shown in FIG. 2; therefore, the identical or similar components in these embodiments are represented by the identical or similar reference numbers and will not be further explained. The difference between the repeat unit sets 200 and 100 lies in that each repeat unit 200 is constituted by thirteen sub-pixels. The thirteen sub-pixels are four first color sub-pixels R, four second color sub-pixels G, four third color sub-pixels B, and one fourth color sub-pixel W. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto.

With reference to FIG. 6, in the first row in the repeat unit set 200, the first color sub-pixel R, the second color sub-pixel G, the third color sub-pixel B, the fourth color sub-pixel W, the first color sub-pixel R, the second color sub-pixel G, and the third color sub-pixel B are arranged from left to right, and the arrangement in the second row is the same as that in the first row. Similarly, the fourth color sub-pixel W is located in both of the first and second rows.

As shown in FIG. 6, two first color sub-pixels R in the first row are electrically connected to the first data line DL1 and the fifth data line DL5, respectively, and the two first color sub-pixels R are electrically connected to the first scan line SL1. Two first color sub-pixels R in the second row are electrically connected to the first data line DL1 and the fifth data line DL5, respectively, and the two first color sub-pixels R are electrically connected to the second scan line SL2. Two second color sub-pixels G in the first row are electrically connected to the second data line DL2 and the sixth data line DL6, respectively, and the two second color sub-pixels G in the first row are electrically connected to the first scan line SL1. Two second color sub-pixels G in the second row are electrically connected to the second data line DL2 and the sixth data line DL6, respectively, and the two second color sub-pixels G in the second row are electrically connected to the second scan line SL2. Two third color sub-pixels B in the first row are electrically connected to the third data line DL3 and the seventh data line DL7, respectively, and the two third color sub-pixels B are electrically connected to the first scan line SL1. Two third color sub-pixels B in the second row are electrically connected to the third data line DL3 and the seventh data line DL7, respectively, and the two third color sub-pixels B are electrically connected to the second scan line SL2. Note that the fourth color sub-pixel W in the repeat unit set 200 is electrically connected to the fourth data line DL4, and the fourth color sub-pixel W is electrically connected to one of the first scan line SL1 and the second scan line SL2, for instance. That is, in the present embodiment, the three primary color RGB signals in the first and second rows can be transmitted to the fourth color sub-pixel W at one time; through the corresponding algorithm, the three primary color RGB signals can be converted into the RGBW image corresponding to the backlight brightness of the display panel.

Similarly, in the present embodiment, the second long side length L2 of the fourth color sub-pixel W is greater than the first long side length L1 of each of the first, second, and third color sub-pixels R, G, and B, and the second long side length L2 is twice the first long side length L1; however, the invention is not limited thereto. Besides, in the present embodiment, the second short side length S2 of the fourth color sub-pixel W is less than the first short side length S1 of each of the first, second, and third color sub-pixels R, G, and B, and the second short side length S2 is half the first short side length S1; however, the invention is not limited thereto. According to the present embodiment, an area of each of the first color sub-pixels R, an area of each of the second color sub-pixels G, and an area of each of the third color sub-pixels B are equal, and the area of each of the first, second, and third color sub-pixels R, G, and B is substantially equal to an area of the fourth color sub-pixel W. However, the invention is not limited to the above.

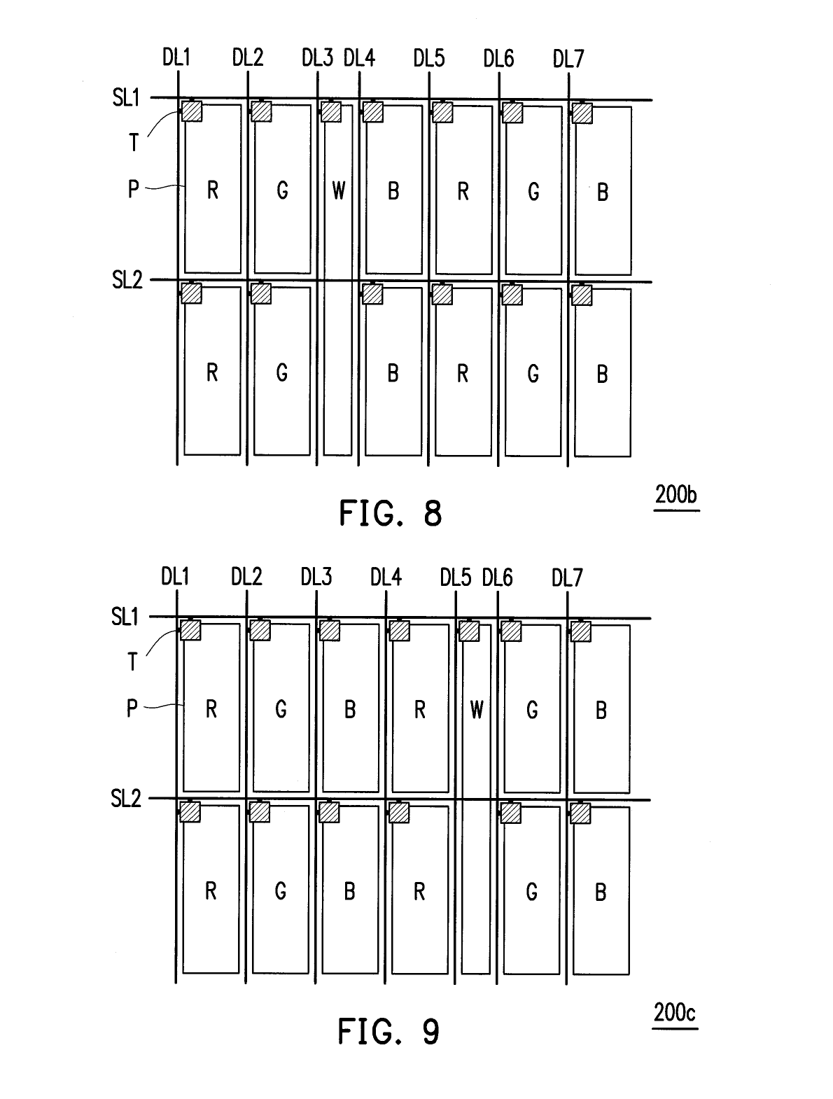

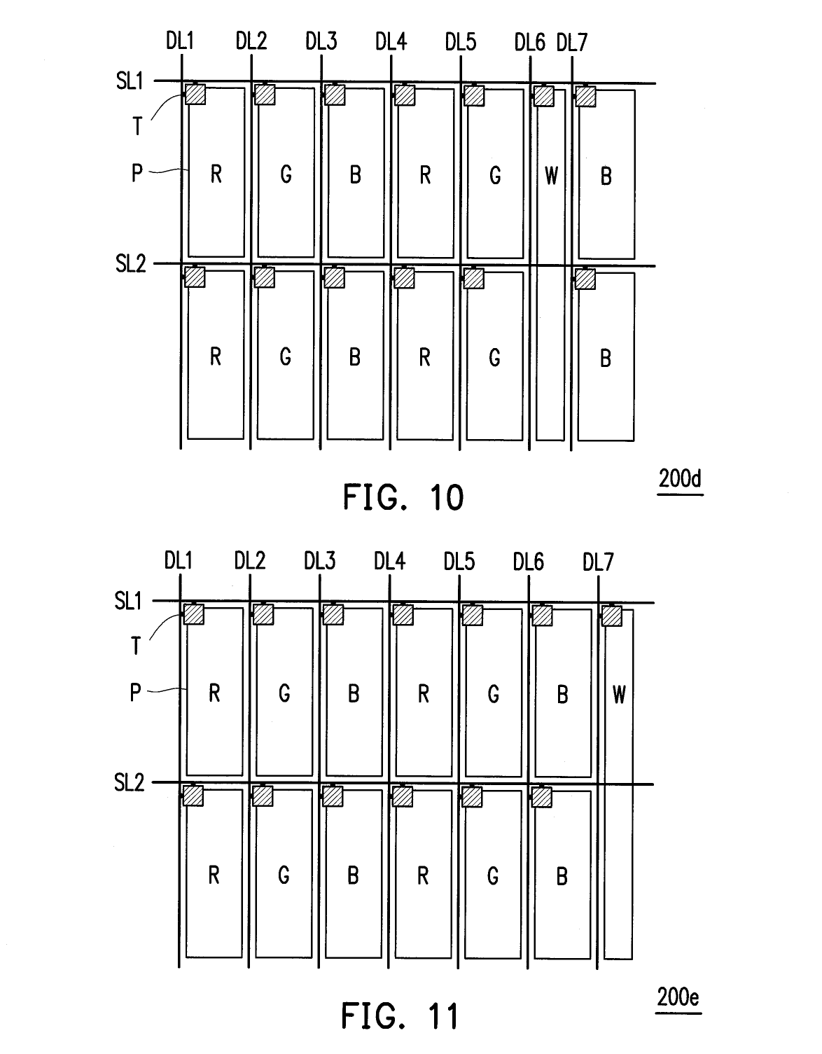

FIG. 7 is a schematic top view illustrating another repeat unit set according to the second embodiment of the invention. FIG. 8 is a schematic top view illustrating still another repeat unit set according to the second embodiment of the invention. FIG. 9 is a schematic top view illustrating still another repeat unit set according to the second embodiment of the invention. FIG. 10 is a schematic top view illustrating another repeat unit set according to the second embodiment of the invention. FIG. 11 is a schematic top view illustrating still another repeat unit set according to the second embodiment of the invention. With reference to FIG. 6 to FIG. 11, the repeat unit sets 200a, 200b, 200c, 200d, and 200e respectively shown in FIG. 7 to FIG. 11 are similar to the repeat unit set 200 illustrated in FIG. 6; therefore, the identical or similar components in these embodiments are represented by the identical or similar reference numbers and will not be further explained. The difference among the repeat unit sets 200, 200a, 200b, 200c, 200d, and 200e lies in the arrangement of the fourth color sub-pixel W relative to the arrangement of the first, second, and third color sub-pixels R, G, and B. Hence, the relative arrangement is elaborated below.

As shown in FIG. 7, compared to the repeat unit set 200 in which the fourth color sub-pixel W is located between the third color sub-pixel B and the first color sub-pixel R, the repeat unit set 200a has the fourth color sub-pixel W located between the first color sub-pixel R (electrically connected to the first data line DL1) and the second color sub-pixel G (electrically connected to the third data line DL3). According to the present embodiment, the fourth color sub-pixel W in the repeat unit set 200a is electrically connected to the second data line DL2, and the fourth color sub-pixel W is electrically connected to one of the first scan line SL1 and the second scan line SL2, for instance. Similarly, the fourth color sub-pixel W is located in both of the first and second rows.

In FIG. 8, the repeat unit set 200b has the fourth color sub-pixel W located between the second color sub-pixel G (electrically connected to the second data line DL2) and the third color sub-pixel B (electrically connected to the fourth data line DL4). Note that the fourth color sub-pixel W in the repeat unit set 200b is electrically connected to the third data line DL3, and the fourth color sub-pixel W is electrically connected to one of the first scan line SL1 and the second scan line SL2, for instance. Similarly, the fourth color sub-pixel W is located in both of the first and second rows.

In FIG. 9, the repeat unit set 200c has the fourth color sub-pixel W located between the first color sub-pixel R (electrically connected to the fourth data line DL4) and the second color sub-pixel G (electrically connected to the sixth data line DL6). According to the present embodiment, the fourth color sub-pixel W in the repeat unit set 200c is electrically connected to the fifth data line DL5, and the fourth color sub-pixel W is electrically connected to one of the first scan line SL1 and the second scan line SL2, for instance. Similarly, the fourth color sub-pixel W is located in both of the first and second rows.

In FIG. 10, the repeat unit set 200d has the fourth color sub-pixel W located between the second color sub-pixel G (electrically connected to the fifth data line DL5) and the third color sub-pixel B (electrically connected to the seventh data line DL7). According to the present embodiment, the fourth color sub-pixel W in the repeat unit set 200d is electrically connected to the sixth data line DL6, and the fourth color sub-pixel W is electrically connected to one of the first scan line SL1 and the second scan line SL2, for instance. Similarly, the fourth color sub-pixel W is located in both of the first and second rows.

In FIG. 11, the repeat unit set 200e has the fourth color sub-pixel W located on the right-hand side of the third color sub-pixel B (electrically connected to the sixth data line DL6). According to the present embodiment, the fourth color sub-pixel W in the repeat unit set 200e is electrically connected to the seventh data line DL7, and the fourth color sub-pixel W is electrically connected to one of the first scan line SL1 and the second scan line SL2, for instance. Similarly, the fourth color sub-pixel W is located in both of the first and second rows.

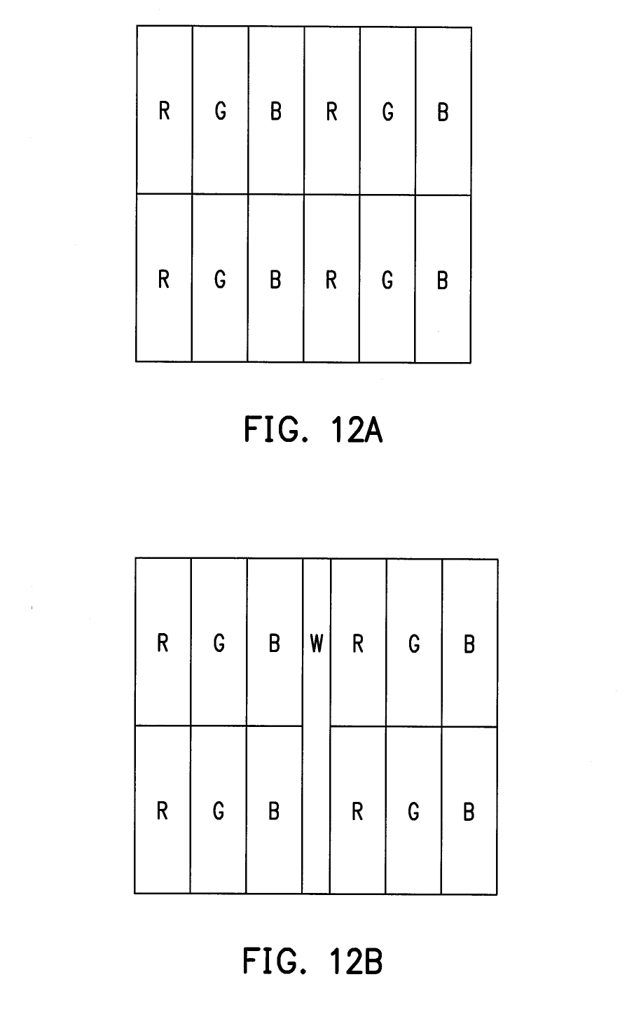

FIG. 12A is a schematic top view illustrating a conventional RGB pixel array. FIG. 12B is a schematic top view illustrating a RGBW pixel array according to a second embodiment of the invention. To clearly illustrate the invention, the driver device T, the scan lines, and the data lines are omitted in FIG. 12A and FIG. 12B. Besides, FIG. 12B shows the exemplary repeat unit set 200, while the RGBW pixel array provided in the present embodiment may be any of the repeat unit sets 200a, 200b, 200c, 200d, and 200e, which should however not be construed as a limitation to the invention. With reference to FIG. 12A and FIG. 12B, the area of each of the first color sub-pixels R, the second color sub-pixels G, and the third color sub-pixels B in the repeat unit set 200 in the RGBW pixel array provided herein is equal to the area of each of the sub-pixels R, G, and B in the conventional RGB pixel array. Namely, the area of the repeat unit set 200 in the RGBW pixel array provided in the present embodiment is greater than the area of two RGB repeat unit sets in the conventional RGB pixel array. Thereby, the transmittance of the display panel having the RGBW pixel array can be improved according to the present embodiment.

It should be mentioned that when a full-white image is displayed by a RGBW pixel array having the repeat unit set 200, 200a, 200b, 200c, 200d, or 200e described herein, the transmittance of said RGBW pixel array may be raised to 136% of the transmittance of the conventional RGB pixel array; when a pure color image is displayed by the RGBW pixel array having the repeat unit set 200, 200a, 200b, 200c, 200d, or 200e, the transmittance of said RGBW pixel array is slightly reduced to 97% of the transmittance of the conventional RGB pixel array. Accordingly, the transmittance of the RGBW pixel array of the present embodiment is 1.14 times the transmittance of the conventional RGBW pixel array while the pure color image is displayed; thereby, the issue of the overly dark pure color image can be effectively resolved, and the overall brightness of the display panel can be enhanced.

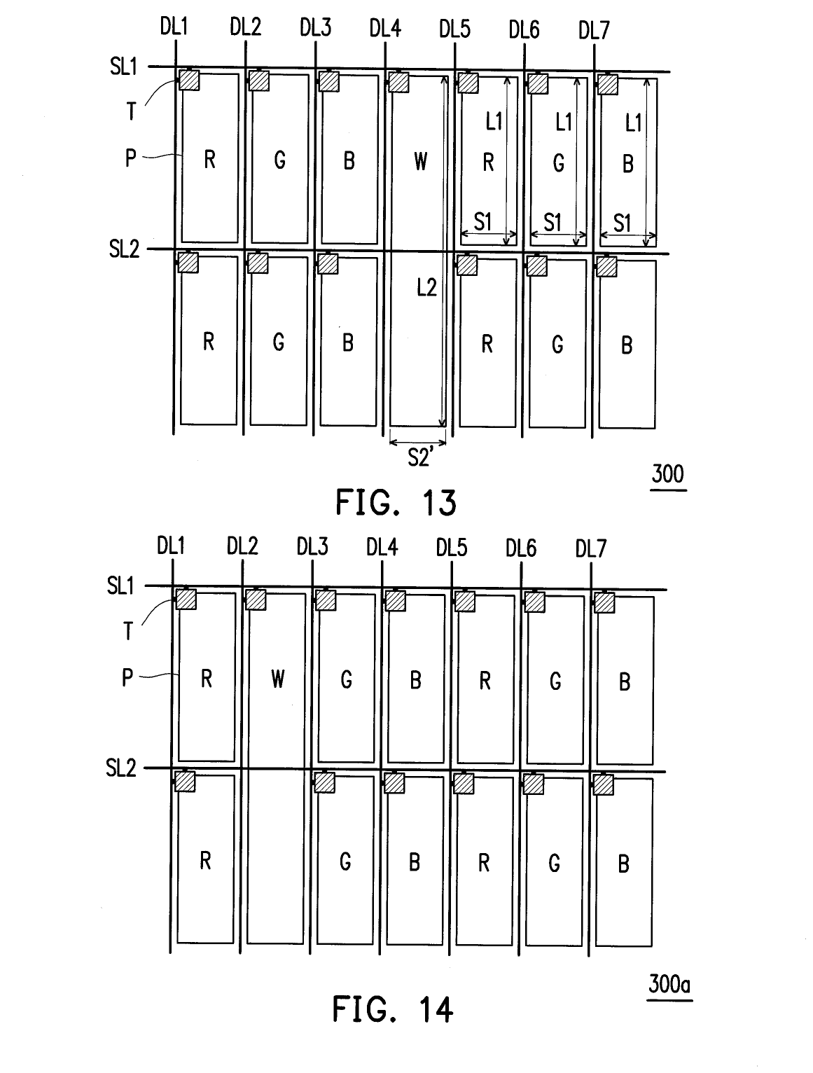

FIG. 13 is a schematic top view illustrating a repeat unit set according to a third embodiment of the invention. With reference to FIG. 6 and FIG. 13, the repeat unit set 300 shown in FIG. 13 is similar to the repeat unit set 200 shown in FIG. 6; therefore, the identical or similar components in these embodiments are represented by the identical or similar reference numbers and will not be further explained. Each of the repeat unit sets 300 and 200 are constituted by thirteen sub-pixels consisting of four first color sub-pixels R, four second color sub-pixels G, four third color sub-pixels B, and one fourth color sub-pixel W, and the relative arrangement of the sub-pixels in the repeat unit set 300 is the same as that in the repeat unit set 200. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto.

The difference between the repeat unit sets 300 and 200 lies in that the area of the fourth color sub-pixel W of the repeat unit set 300 is twice the area of the fourth color sub-pixel W of the repeat unit set 200. As shown in FIG. 13, each of the first color sub-pixels R, the second color sub-pixels G, and the third color sub-pixels B has a first short side length S1 and a first long side length L1. The fourth color sub-pixel W has a second short side length S2′ and a second long side length L2. In the present embodiment, the second long side length L2 is greater than the first long side length L1, and the second long side length L2 is twice the first long side length L1; however, the invention is not limited thereto. Note that in the repeat unit set 300 the second short side length S2′ of the fourth color sub-pixel W is equal to the first short side length S1 of each of the first, second, and third color sub-pixels R, G, and B. In the repeat unit set 300, an area of each of the first color sub-pixels R, an area of each of the second color sub-pixels G, and an area of each of the third color sub-pixels B are equal, and the area of each of the first, second, and third color sub-pixels R, G, and B is half an area of the fourth color sub-pixel W.

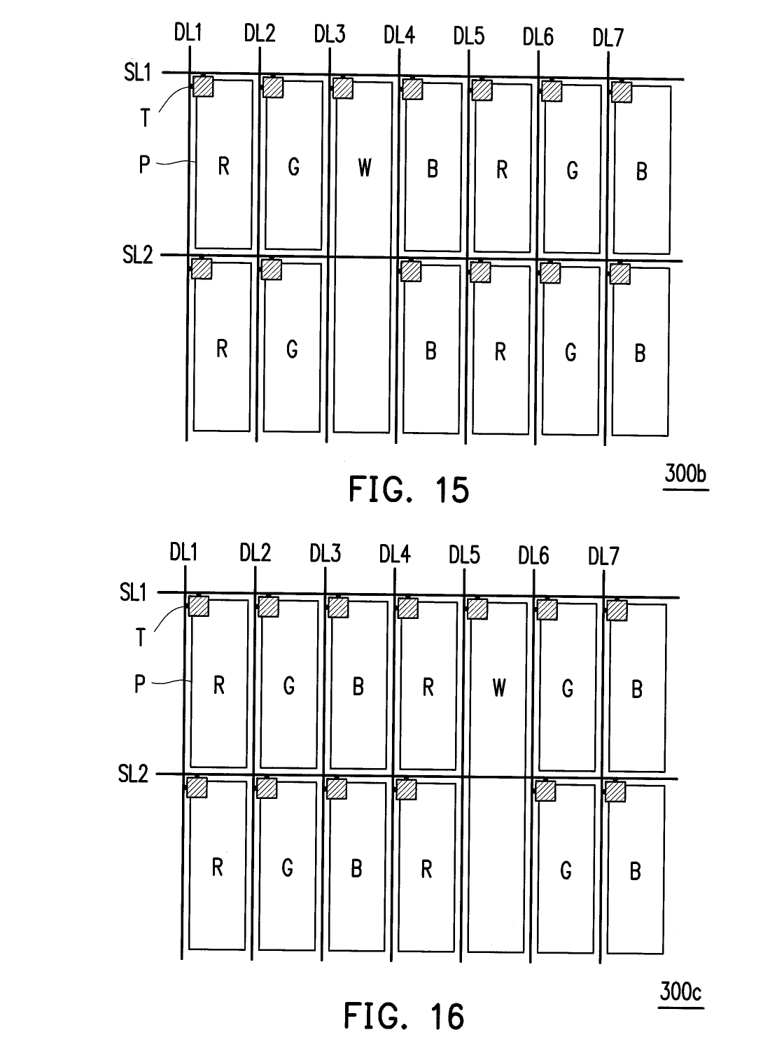

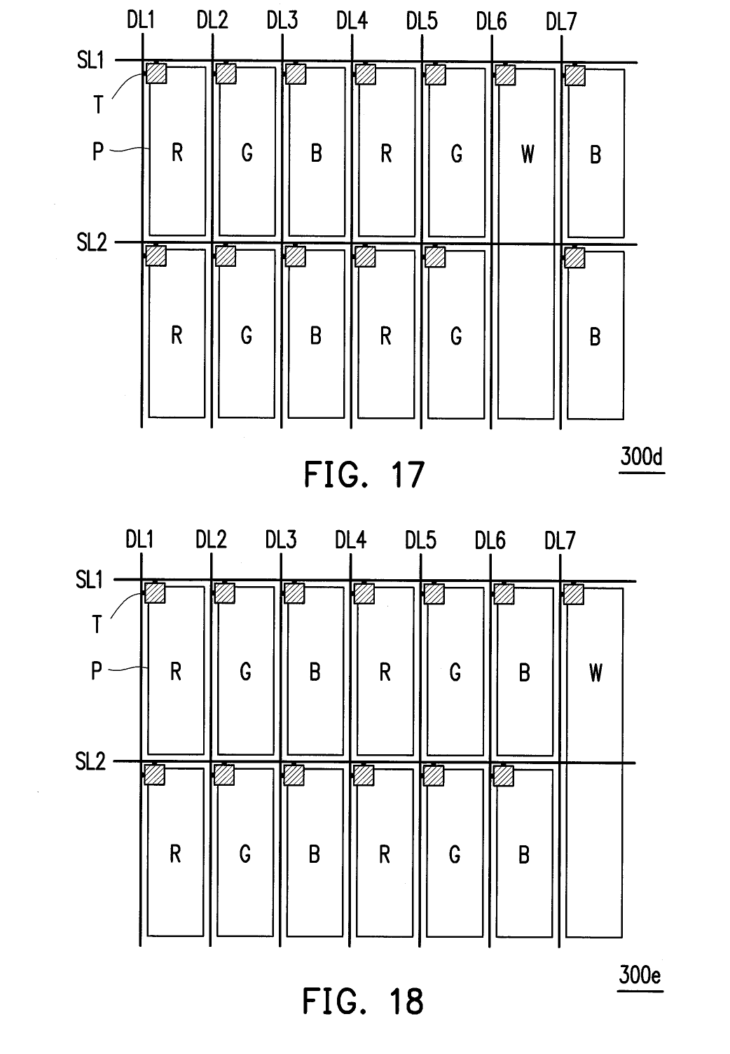

FIG. 14 is a schematic top view illustrating another repeat unit set according to the third embodiment of the invention. FIG. 15 is a schematic top view illustrating still another repeat unit set according to the third embodiment of the invention. FIG. 16 is a schematic top view illustrating still another repeat unit set according to the third embodiment of the invention. FIG. 17 is a schematic top view illustrating still another repeat unit set according to the third embodiment of the invention. FIG. 18 is a schematic top view illustrating still another repeat unit set according to the third embodiment of the invention. The repeat unit set 300a depicted in FIG. 14 is similar to the repeat unit set 200a depicted in FIG. 7, the repeat unit set 300b depicted in FIG. 15 is similar to the repeat unit set 200b depicted in FIG. 8, the repeat unit set 300c depicted in FIG. 16 is similar to the repeat unit set 200c depicted in FIG. 9, the repeat unit set 300d depicted in FIG. 17 is similar to the repeat unit set 200d depicted in FIG. 10, and the repeat unit set 300e depicted in FIG. 18 is similar to the repeat unit set 200e depicted in FIG. 11; therefore, the identical or similar components in these drawings are represented by the identical or similar reference numbers and will not be further explained.

The arrangements of the first color sub-pixels R, the second color sub-pixels G, the third color sub-pixels B, and the fourth color sub-pixel W in the repeat unit sets 300, 300a, 300b, 300c, 300d, and 300e are the same as the arrangements of the first color sub-pixels R, the second color sub-pixels G, the third color sub-pixels B, and the fourth color sub-pixel W in the corresponding repeat unit sets 200, 200a, 200b, 200c, 200d, and 200e, and the area of each of the first, second, and third color sub-pixels R, G, and B is equal. The difference between the repeat unit sets 300, 300a, 300b, 300c, 300d, and 300e and the corresponding repeat unit sets 200, 200a, 200b, 200c, 200d, and 200e lies in the area of the fourth color sub-pixel W. With reference to FIG. 14 to FIG. 18, the area of each of the first, second, and third color sub-pixels R, G, and B is half the area of the fourth color sub-pixel W.

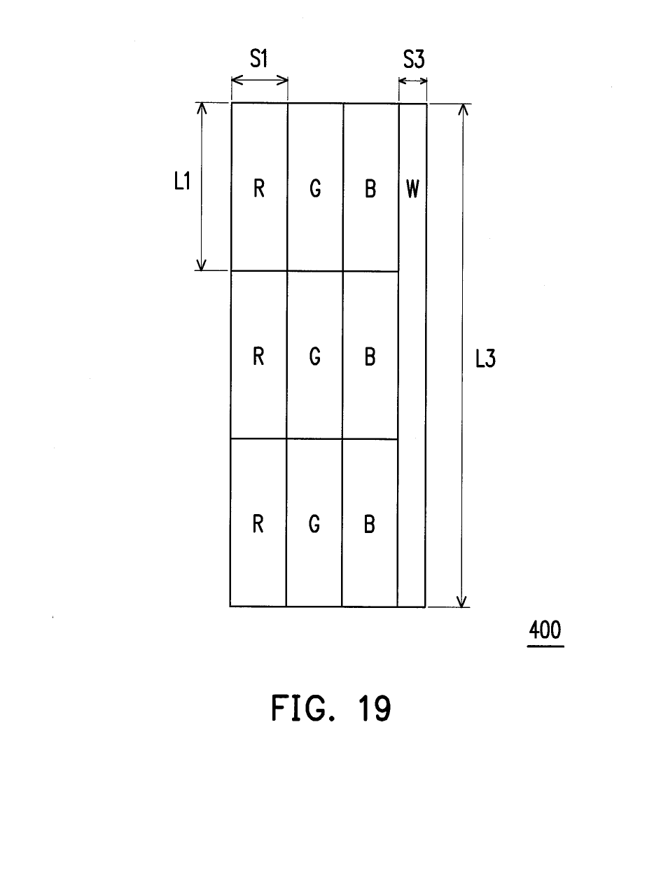

FIG. 19 is a schematic top view illustrating a repeat unit set according to a fourth embodiment of the invention. With reference to FIG. 2 and FIG. 19, the repeat unit set 400 provided in the present embodiment is similar to the repeat unit set 100 given in the embodiment provided above; therefore, the identical or similar components in these embodiments are represented by the identical or similar reference numbers and will not be further explained. The difference between the repeat unit sets 400 and 100 lies in the shape of the fourth color sub-pixel W in the repeat unit sets 400 and 100.

As shown in FIG. 19, each of the first color sub-pixels R, the second color sub-pixels G, and the third color sub-pixels B has a first short side length S1 and a first long side length L1. The fourth color sub-pixel W has a second short side length S3 and a second long side length L3. According to the present embodiment, the second long side length L3 of the fourth color sub-pixel W is greater than the first long side length L1 of each of the first, second, and third color sub-pixels R, G, and B, and the second long side length L3 is three times the first long side length L1; however, the invention is not limited thereto. In another embodiment, the second long side length L3 of the fourth color sub-pixel W can be at least three times the first long side length L1 of each of the first, second, and third color sub-pixels R, G, and B. According to the present embodiment, the second short side length S3 of the fourth color sub-pixel W is less than the first short side length S1 of each of the first, second, and third color sub-pixels R, G, and B, and the second short side length S3 is one third the first short side length S1; however, the invention is not limited thereto. In another embodiment, the second short side length S3 of the fourth color sub-pixel W can be at most one third the first short side length S1 of each of the first, second, and third color sub-pixels R, G, and B. According to the present embodiment, an area of each of the first color sub-pixels R, an area of each of the second color sub-pixels G, and an area of each of the third color sub-pixels B are equal, and the area of each of the first, second, and third color sub-pixels R, G, and B is substantially equal to an area of the fourth color sub-pixel W. However, the invention is not limited to the above.

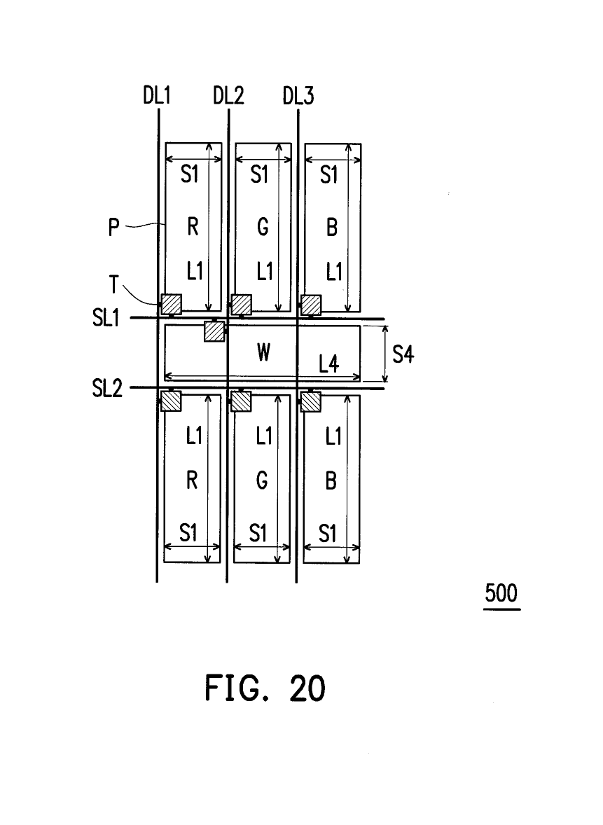

FIG. 20 is a schematic top view illustrating a repeat unit set according to a fifth embodiment of the invention. With reference to FIG. 20, the repeat unit set 500 provided in the present embodiment includes a first scan line SL1, a second scan line SL2, a first data line DL1, a second data line DL2, a third data line DL3, and seven sub-pixels. The seven sub-pixels are two first color sub-pixels R, two second color sub-pixels G, two third color sub-pixels B, and a fourth color sub-pixel W. However, the invention is not limited thereto; in other embodiments of the invention, each repeat unit set in the pixel array may be constituted by more than two first color sub-pixels R, more than two second color sub-pixels G, more than two third color sub-pixels B, and one fourth color sub-pixel W. According to the present embodiment, the first color sub-pixels R are red sub-pixels, the second color sub-pixels G are green sub-pixels, the third color sub-pixels B are blue sub-pixels, and the fourth color sub-pixel W is a white sub-pixel; however, the invention is not limited thereto.

With reference to FIG. 20, in the first row in the repeat unit set 500, the first color sub-pixel R, the second color sub-pixel G, and the third color sub-pixel B are arranged from left to right, and the arrangement in the third row is the same as that in the first row. Note that the fourth color sub-pixel W is located in the second row between the first row and the third row; that is, the fourth color sub-pixel W is located between two adjacent first color sub-pixels R, between two adjacent second color sub-pixels G, and between two adjacent third color sub-pixels B.

The driver device T of each sub-pixel can be electrically connected to the corresponding first scan line SL1, the corresponding second scan line SL2, the corresponding first data line DL1, the corresponding second data line DL2, and the corresponding third data line DL3. As shown in FIG. 20, two first color sub-pixels R are electrically connected to the first data line DL1 and are electrically connected to the first scan line SL1 and the second scan line SL2, respectively. Two second color sub-pixels G are electrically connected to the second data line DL2 and are electrically connected to the first scan line SL1 and the second scan line SL2, respectively. Two third color sub-pixels B are electrically connected to the third data line DL3 and are electrically connected to the first scan line SL1 and the second scan line SL2, respectively. The fourth color sub-pixel W can be electrically connected to the first data line DL1, the second data line DL2, or the third data line DL3, and the fourth color sub-pixel W can be electrically connected to the first scan line SL1 or the second scan line SL1, which should however not be construed as a limitation to the invention.

As shown in FIG. 20, each of the first color sub-pixels R, the second color sub-pixels G, and the third color sub-pixels B has a short side length S1 and a first long side length L1. The fourth color sub-pixel W has a short side length S4 and a long side length L4. Note that in the present embodiment the long side length L4 of the fourth color sub-pixel W is parallel to the short side length S1 of each of the first, second, and third color sub-pixels R, G, and B. According to the present embodiment, the long side length L4 of the fourth color sub-pixel W is three times the short side length S1 of each of the first, second, and third color sub-pixels R, G, and B; however, the invention is not limited thereto. In the present embodiment, the short side length S4 of the fourth color sub-pixel W is no larger than one third the short side length S1 of each of the first, second, and third color sub-pixels R, G, and B; however, the invention is not limited thereto. According to the present embodiment, an area of each of the first color sub-pixels R, an area of each of the second color sub-pixels G, and an area of each of the third color sub-pixels B are equal, and the area of each of the first, second, and third color sub-pixels R, G, and B is substantially equal to an area of the fourth color sub-pixel W. However, the invention is not limited to the above.

As provided above, the long side length and the short side length of each sub-pixel are specifically defined as the long side length and the short side length of the pixel electrode P corresponding to the sub-pixel, and the area of the sub-pixel is specifically defined as the area of the pixel electrode P corresponding to the sub-pixel.

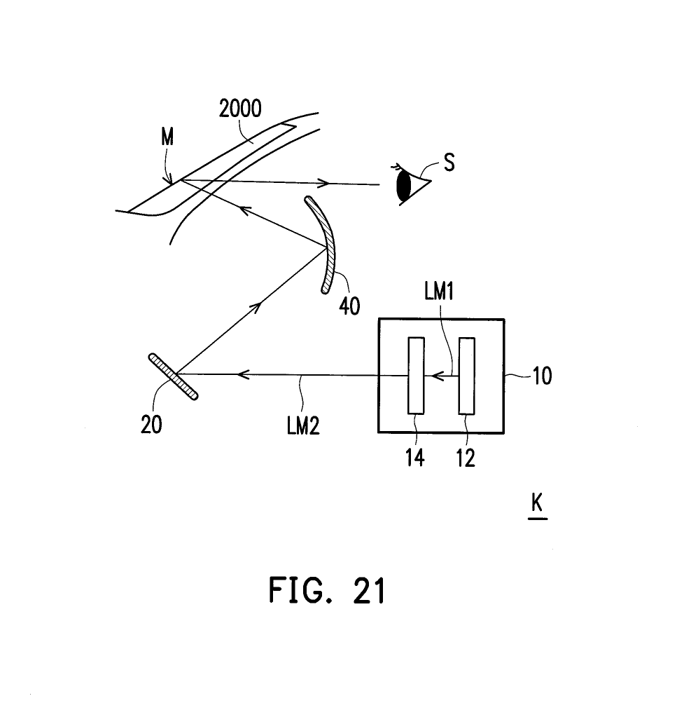

FIG. 21 is a schematic view illustrating a head up display (HUD) according to an embodiment of the invention. With reference to FIG. 21, the HUD K is located below a light transmissive windshield 2000 of a vehicle. In the present embodiment, the vehicle is a car, and the light transmissive windshield 2000 is the glass windshield in front of the driver, for instance. Nevertheless, the invention is not limited thereto; in other embodiments of the invention, the vehicle may be a train, an airplane, a ship, a submarine, or any other type of vehicle, and the light transmissive windshield 2000 may be a window configured around the passenger or on the vehicle.

The HUD K may include a display module 10. An illumination beam LM1 emitted by the light emitting unit 12 of the display module 10 may pass through the display panel 14 and may then be converted into a plurality of image beams LM2. The image beams LM2 may be projected onto the light transmissive windshield 2000 of the vehicle to generate an image M for a user S to watch.

To be specific, the HUD K provided herein may selectively include an optical component 20 located on a transmission path of the image beams LM2. According to the present embodiment, the optical component 20 is a planar reflective mirror, for instance. The optical component 20 can change the transmission direction of the image beams, and thereby the image beams LM2 may be transmitted to the light transmissive windshield 2000 to generate an image. According to the present embodiment, the HUD K may selectively include another optical component 40. The optical component 40 is located on a transmission path of the image beams LM2 from the optical component 20. According to the present embodiment, the optical component 40 is a curved reflective mirror, for instance. The optical component 40 not only can again change the transmission direction of the image beams L2, extend the transmission path of the image beams, and thereby increase the dimension of the image M but also can compensate the aberration of the image M generated on the curved light transmissive windshield 2000, such that the user S is allowed to watch the resultant image with favorable quality. The type of the HUD described herein should however not be construed as a limitation to the invention, and the HUD may have multiple optical components according to different demands. For instance, the optical path of the HUD may be constituted by two or three reflective optical components and one lens component.

Note that the display panel 14 of the HUD K includes the pixel array constituted by any of said repeat unit sets provided in the previous embodiments. Thereby, the display panel 14 may be characterized by the outstanding transmittance, and the issue of the pure color image with the relatively low brightness and the white color image with the relatively high brightness does not occur in the resultant image M. Moreover, the increasing transmittance of the display panel 14 is conducive to the reduction of power consumption of the backlight plate of the display panel 14, and thus the overall power consumption of the HUD K is reduced.

To sum up, in each repeat unit set of the pixel array described herein, the fourth color sub-pixel is added, and the long side length of the fourth color sub-pixel is greater than the long side length of each of the first, second, and third color sub-pixels. Thereby, the issue of the pure color image with the relatively low brightness and the white color image with the relatively high brightness can be resolved in the pixel array provided herein, and the transmittance of the display panel can be enhanced.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A pixel array comprising a plurality of repeat unit sets, each of the repeat unit sets comprising:
a first scan line and a second scan line;
a first data line, a second data line, a third data line, and a fourth data line;
at least two first color sub-pixels electrically connected to the first data line, the at least two first color sub-pixels being electrically connected to the first scan line and the second scan line, respectively;
at least two second color sub-pixels electrically connected to the second data line, the at least two second color sub-pixels being electrically connected to the first scan line and the second scan line, respectively;
at least two third color sub-pixels electrically connected to the third data line, the at least two third color sub-pixels being electrically connected to the first scan line and the second scan line, respectively; and
a fourth color sub-pixel electrically connected to the fourth data line, the fourth color sub-pixel being electrically connected to the first scan line or the second scan line, wherein
each of the first color sub-pixels, the second color sub-pixels, and the third color sub-pixels has a first short side length and a first long side length, the fourth color sub-pixel has a second short side length and a second long side length, and the second long side length is greater than the first long side length.

2. The pixel array as recited in claim 1, wherein the second long side length is at least twice the first long side length.

3. The pixel array as recited in claim 1, wherein the second short side length is less than or equal to the first short side length.

4. The pixel array as recited in claim 3, wherein the second short side length is at most half the first short side length.

5. The pixel array as recited in claim 1, wherein an area of each of the first color sub-pixels, an area of each of the second color sub-pixels, and an area of each of the third color sub-pixels are equal, and the area of each of the first, second, and third color sub-pixels is substantially equal to an area of the fourth color sub-pixel.

6. The pixel array as recited in claim 1, wherein an area of each of the first color sub-pixels, an area of each of the second color sub-pixels, and an area of each of the third color sub-pixels are equal, and the area of each of the first, second, and third color sub-pixels is half an area of the fourth color sub-pixel.

7. The pixel array as recited in claim 1, wherein the first color sub-pixels are red sub-pixels, the second color sub-pixels are green sub-pixels, the third color sub-pixels are blue sub-pixels, and the fourth color sub-pixel is a white sub-pixel.

8. The pixel array as recited in claim 1, wherein each of the repeat unit sets has seven sub-pixels comprising two of the first color sub-pixels, two of the second color sub-pixels, two of the third color sub-pixels, and the fourth color sub-pixel.

9. The pixel array as recited in claim 1, wherein each of the repeat unit sets has thirteen sub-pixels comprising four of the first color sub-pixels, four of the second color sub-pixels, four of the third color sub-pixels, and the fourth color sub-pixel.

10. A pixel array comprising a plurality of repeat unit sets, each of the repeat unit sets comprising:
a first scan line and a second scan line;
a first data line, a second data line, and a third data line
at least two first color sub-pixels electrically connected to the first data line, the at least two first color sub-pixels being electrically connected to the first scan line and the second scan line, respectively;
at least two second color sub-pixels electrically connected to the second data line, the at least two second color sub-pixels being electrically connected to the first scan line and the second scan line, respectively;
at least two third color sub-pixels electrically connected to the third data line, the at least two third color sub-pixels being electrically connected to the first scan line and the second scan line, respectively; and
a fourth color sub-pixel electrically connected to the first data line, the second data line, or the third data line, the fourth color sub-pixel being electrically connected to the first scan line or the second scan line, wherein
a long side length of the fourth color sub-pixel is parallel to short side lengths of the first, second, and third color sub-pixels.

11. The pixel array as recited in claim 10, wherein the fourth color sub-pixel is located between two adjacent first color sub-pixels of the at least two first color sub-pixels, between two adjacent second color sub-pixels of the at least two second color sub-pixels, and between two adjacent third color sub-pixels of the at least two third color sub-pixels.

12. The pixel array as recited in claim 10, wherein the long side length of the fourth color sub-pixel is at least three times the short side length of each of the first, second, and third color sub-pixels.

13. The pixel array as claimed in claim 10, wherein an area of each of the first color sub-pixels, an area of each of the second color sub-pixels, and an area of each of the third color sub-pixels are equal, and the area of each of the first, second, and third color sub-pixels is substantially equal to an area of the fourth color sub-pixel.

14. A head up display comprising:
a display module comprising:
a display panel comprising the pixel array as recited in claim 1; and
a plurality of light emitting units adapted to emit an illumination beam passing through the display panel to be converted into a plurality of image beams.
